(19) United States
(12) Patent Application Publication
(10) Pub. No.: US 2026/0347263 A1
(43) Pub. Date: Nov. 5, 2026

(54) MANUFACTURING AN ELECTROCERAMIC COMPOSITE STRUCTURE

(71) Applicant: Oulun yliopisto, Oulu (FI)

(72) Inventors: Mikko NELO, Oulu (FI); Seppo NISSILÄ, Oulu (FI); Tuomo SIPONKOSKI, Oulu (FI); Yang BAI, Oulu (FI); Heli JANTUNEN, Oulu (FI); Jari JUUTI, Oulu (FI)

(21) Appl. No.: 19/488,780

(22) PCT Filed: May 28, 2024
(86) PCT No.: PCT/FI2024/050276

§ 371 Date: Nov. 28, 2025

(30) Foreign Application Priority Data
May 29, 2023 (FI) 20235597

(51) Int. Cl. C04B 35/491; C04B 35/632

(52) U.S. Cl. CPC C04B 35/491; C04B 35/6325; C04B 2235/3249; C04B 2235/48; C04B 2235/6028; C04B 2235/604; C04B 2235/94; C04B 2235/96

(57) ABSTRACT

A method is disclosed for manufacturing a hollow electroceramic composite structure, comprising providing sacrificial material comprising water-soluble salt, compressed into a desired shape. A combination of electroceramic powder and flowable metal oxide precursor is placed on a surface of the compressed sacrificial material, and a pressure of 100-500 MPa is applied to said combination. The combination is exposed, under said pressure to a heat treatment at a temperature of 20 °C to 500 °C, for a predefined time period, for forming electroceramic composite material on the surface of the sacrificial material, wherein at least part of the sacrificial material is allowed to react with the metal oxide precursor to form metal oxide in the electroceramic composite material. Optionally any unreacted sacrificial material is removed from the electroceramic composite material by treatment with water.

### FIELD OF THE INVENTION

The present invention relates to electroceramic composite materials, and more particularly to manufacturing an electroceramic composite structure.

### BACKGROUND ART

In electroceramics, manufacturing of hollow, concave or convex parts with exact dimensions is challenging due to the deformation of the materials during high temperature sintering. The parts have to be machined into a desired shape, which is expensive, slow and causes waste of material. Another option is to use a ceramic-polymer composite that can be heat compressed into the desired shape. A problem with the ceramic-polymer composite is lower heat resistance and lower electrical performance.

Multilayer ceramic materials have been produced by using co-sintering of ceramic materials (LTCC) inside of which conductive structures have been prepared from silver by sintering. The manufacturing temperature of this type of material is typically 850 °C. The high manufacturing temperature causes challenges or even limits the integration of different components inside the co-sintered ceramic material.

Materials that can be sintered at a lower temperature have been developed, but their electromechanical properties are not good.

### SUMMARY

The following presents a simplified summary of features disclosed herein to provide a basic understanding of some exemplary aspects of the invention. This summary is not an extensive overview of the invention. It is not intended to identify key/critical elements of the invention or to delineate the scope of the invention. Its sole purpose is to present some concepts disclosed herein in a simplified form as a prelude to a more detailed description.

According to an aspect, there is provided the subject matter of the independent claims. Embodiments are defined in the dependent claims.

One or more examples of implementations are set forth in more detail in the description below. Other features will be apparent from the description, and from the claims.

### BRIEF DESCRIPTION OF THE DRAWINGS

In the following the invention will be described in greater detail by means of preferred embodiments with reference to the attached drawings, in which

FIGS. 1 to 6 illustrate manufacturing of electroceramic composite material according to exemplary embodiments.

### DETAILED DESCRIPTION OF EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising”, “containing” and “including” should be understood as not limiting the described embodiments to consist of only those features that have been mentioned and such embodiments may contain also features/structures that have not been specifically mentioned.

The present invention provides a method for manufacturing a hollow electroceramic composite structure. The present method enables manufacturing of hollow multilayer electroceramic composites. The present method may be used to produce hollow ceramic electronic components and structures at very low temperatures. The present method enables to produce all-ceramic, multilayer and/or coated electronic components and structures at very low temperatures.

The present invention involves a low temperature manufacturing method. By the low-temperature manufacturing method according to the present invention, the electroceramic composite can also be made into concave, convex, hollow and/or structures combining these shapes, by using a water-soluble, heat resistant, and pressure-resistant substance as a sacrificial material, e.g. NaCl, KCl, LiCl, MgCl₂, CaCl₂, magnesium sulphate, barium hydroxide, or any combination thereof.

In an embodiment, the composition of the sacrificial material may be chosen in such a way that the sacrificial material releases a compound that reacts with the ceramic material or a binder of the ceramic material during compressing. For example, a reaction of an organometallic compound used as a binder, into a metal oxide may take place at a low temperature. The surface of the composite may also be functionalized by using as the sacrificial material water soluble salt mixed with a compound such as barium hydroxide that reacts with a metal oxide precursor mixed within the ceramic.

In an embodiment, the properties of electroceramic composite may be improved by preparing electrode structures inside the composite from an electrode network, such as conductive metal network, which may be shaped into a desired shape by light compression. The electrode network may also be referred to as a mesh electrode or electrode mesh. Alternatively, the electrode structure may be prepared by coating the sacrificial material with an electrode material, such as conductive printing ink, whereby the ink attaches on the inner surface of the composite material during manufacturing of the electroceramic composite structure.

In an embodiment, the method for manufacturing a hollow electroceramic composite structure comprises a) providing sacrificial material compressed into a desired shape, the sacrificial material comprising water-soluble salt. The method comprises b) placing a combination of electroceramic powder and flowable metal oxide precursor on a surface of the sacrificial material compressed into the desired shape. The method comprises c) applying pressure of 100 MPa to 500 MPa to said combination placed on the surface of the sacrificial material. The method comprises d) exposing combination placed on the surface of the sacrificial material, under said pressure to a heat treatment at a temperature of 20 °C to 500 °C, preferably 80 °C to 500 °C, more preferably 120 °C to 300 °C, for a predefined time period, for forming electroceramic composite material on the surface of the sacrificial material, wherein at least part of the sacrificial material is allowed to react with the metal oxide precursor to form metal oxide in the electroceramic composite material. Optionally the method comprises e) removing any unreacted sacrificial material from the electroceramic composite material by treatment with water.

In an embodiment, the treatment with water may comprise dissolving with water to dissolve said unreacted sacrificial material. The dissolved sacrificial material may then be removed from the electroceramic composite material. Water may also be removed from the electroceramic composite material.

In an embodiment, the water-soluble salt in the sacrificial material may comprise hydrated salt, such as magnesium sulphate, MgCl₂, CaCl₂, and/or barium hydroxide, and anhydrous salt, such as NaCl, KCl, and/or LiCl.

In an embodiment, the allowing of the at least part of the sacrificial material to react with the metal oxide precursor to form the metal oxide in the electroceramic composite material may comprise that crystal water contained in thehydrated salt in the sacrificial material is reacted with the metal oxide precursor to form the metal oxide in the electroceramic composite material. Optionally also the water-soluble salt in the sacrificial material may be reacted with the metal oxide precursor to form the metal oxide in the electroceramic composite material.

In an embodiment, the sacrificial material may comprise a mixture of NaCl, KCl, and/or LiCl, with magnesium sulphate, MgCl₂, CaCl₂, and/or barium hydroxide.

In an embodiment, the water-soluble salt may comprise a mixture of NaCl, KCl, and/or LiCl, with magnesium sulphate, MgCl₂, CaCl₂, and/or barium hydroxide.

In an embodiment, the metal oxide precursor may comprise organotitanate compound, such as titanium metoxide, or the metal oxide precursor may be in a form of a gel or sol-gel.

In an embodiment, the sacrificial material may be compressed into the desired shape by compressing an aqueous solution of the sacrificial material in a preform mould. The aqueous solution of the sacrificial material may be obtained by dissolving the water-soluble salt into water. Optionally water may be removed from compressed sacrificial material by drying.

In an embodiment, said desired shape of the sacrificial material may be a contoured structure, such as a cylinder, lens, prism, polyhedron, sphere, hemisphere, hollow cube, hollow cuboid, or any other 3-dimensional shape.

In an embodiment, the hollow electroceramic composite structure obtained by the method may be a contoured structure, such as a hollow cylinder, lens, hollow prism, hollow polyhedron, hollow sphere, hollow hemisphere, hollow cube, hollow cuboid, or any other hollow 3-dimensional shape.

In an embodiment, the method may comprise providing the electroceramic composite material with an electrode network, by providing the electrode network on the surface of the sacrificial material between steps a) and b). Alternatively, the method may comprise providing the electroceramic composite material with conductive printing ink, by printing the conductive printing ink on the surface of the sacrificial material between steps a) and b).

In an embodiment, the method may comprise providing a layered structure of the electroceramic composite material by, between steps d) and e), preparing a further layer of electroceramic composite material on a surface of a previous layer of the electroceramic composite material, by using said combination and by carrying said heat treatment under said pressure, and providing an electrode network between the electroceramic composite material layers, wherein the electrode network may be provided on the previous layer of the electroceramic composite material before preparing the further layer of electroceramic composite material, or wherein conductive printing ink may be printed between the electroceramic composite material layers, wherein the conductive printing ink may be printed on the previous layer of the electroceramic composite material before preparing the further layer of electroceramic composite material.

In an embodiment, the electrode network comprises metal. The metal may be one or more of aluminium, silver, platinum, copper, brass, and/or steel.

In an embodiment, the sacrificial material may be barium hydroxide hexahydrate, and the flowable metal oxide precursor may be an organotitanate compound. The formed metal oxide may be titanium oxide, and optionally barium titanate may be formed in the hollow electroceramic composite structure.

In an embodiment, the electrode network may form an electrical sensor inside or on a surface of the hollow electroceramic composite structure. Optionally the electrode network may be coated with a catalytic coating.

In an embodiment, the method may comprise providing an electrode network on a surface of the hollow electroceramic composite structure. The electrode network may be added between steps b) and c).

In an embodiment, the heat treatment under said pressure may be carried out in a product mould.

In an embodiment, the electroceramic composite material may be removed from the product mould before the removal of said unreacted sacrificial material from the electroceramic composite material. Alternatively, the electroceramic composite structure may be removed from the product mould after the removal of said unreacted sacrificial material from the electroceramic composite material.

In an embodiment, the electroceramic powder may comprise at least one of PZT, BaₓSr₁₋ₓTiO₃, TiO₂, Al₂O₃, KNBNNO, perovskite material, and ferrite ceramic material.

In an embodiment, the flowable metal oxide precursor may be water-insoluble, In the electroceramic powder, surfaces of electroceramic particles may be covered with the metal oxide precursor, a major fraction of the electroceramic particles having particle diameters within a range 50 μm to 200 μm, and a minor fraction of the electroceramic particles having diameters smaller than the lower limit of said range, the major fraction having a variety of particle diameters.

An embodiment provides a hollow electroceramic composite structure produced by the method described herein.

An embodiment provides a use of sacrificial material comprising water-soluble salt for manufacturing a hollow electroceramic composite structure according to the method described herein.

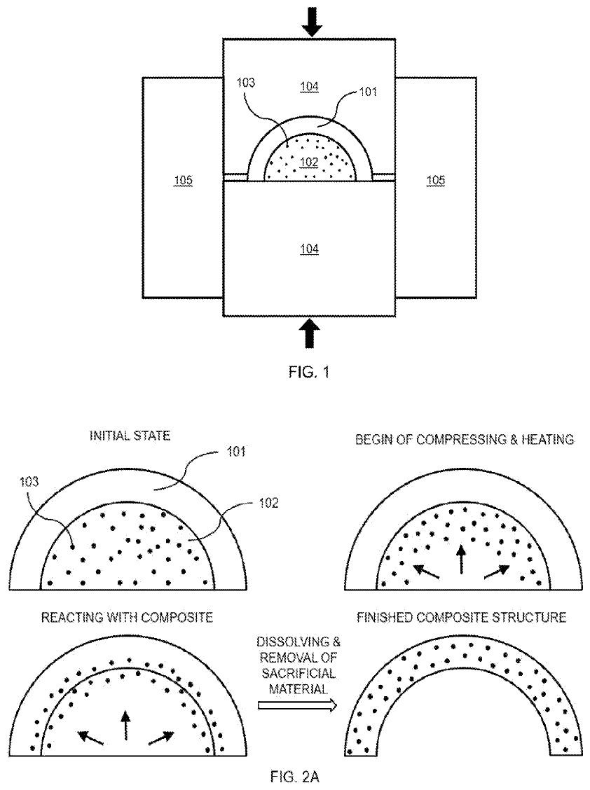

FIGS. 1 and 2A illustrate manufacturing of the electroceramic composite material and different material layers according to an embodiment. FIG. 1 shows the ceramic composite material 101 which may contain layers, on top of the sacrificial material 102 which is to be removed after molding. The sacrificial material comprises a reactive part 103 such as hydrous salt. The manufacturing may be carried out in a mold that comprises a movable product mold piston 104, and a product mold 105. FIG. 2A illustrates the function of the reactive sacrificial material.

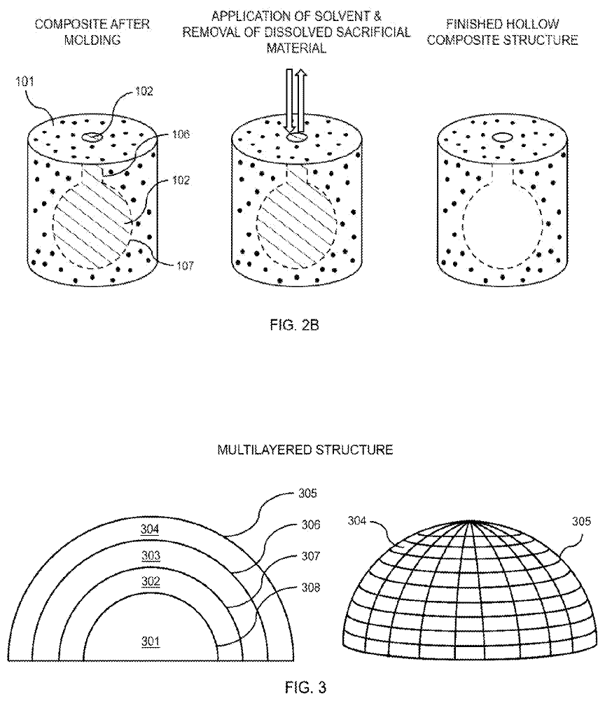

FIG. 3 illustrates an exemplary multi-layer composite according to an embodiment. The layers may be of different electroceramic composite material 302, 303, 304, and an electrically conductive/electrode layer 305, 306, 307, 308 may be provided on top of the ceramic layer 304, in between the ceramic layers 302, 303, 304, and/or between a ceramic layer and the sacrificial material 301 wherein the electrode layer 305, 306, 307, 308 may be mesh-like electrode.

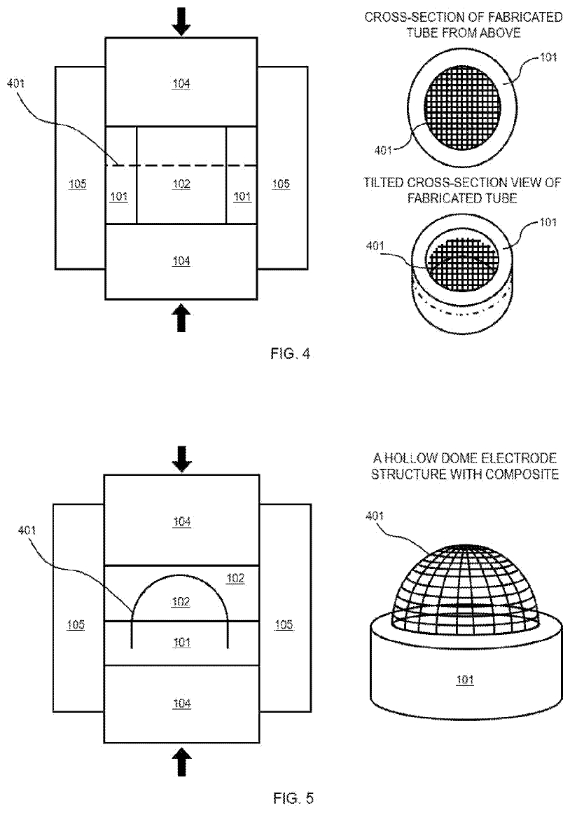

FIG. 4 illustrates manufacturing of a hollow cylinder shaped composite 101 having a mesh-like electrode 401, according to an embodiment. FIG. 5 illustrates manufacturing of a hollow hemispherical shaped composite 101 having a dome shaped electrode network 401. The manufacturing may be carried out in a mold that comprises a movable product mold piston 104, and a product mold 105.

In an embodiment, a hollow electroceramic composite structure is prepared at a low temperature.

In an embodiment, sacrificial material containing water soluble salt is compressed into a desired shape. The sacrificial material comprises, for example, a mixture of sodium chloride with magnesium sulphate or barium hydroxide. The sacrificial material 102 compressed into the desired shape is placed in a mold 105 which enables obtaining dimensions of a final product. Additionally a combination 101 of water-insoluble electroceramic powder and flowable metal oxide precursor is placed in the mold 105 over the sacrificial material compressed into the desired shape. A pressure of 100 MPa to 500 MPa is applied 104 to said combination 101 placed over the sacrificial material 102. Said combination 101 placed on the surface of the sacrificial material 102, is exposed under said pressure to a heat treatment at a temperature of 20 °C to 500 °C, preferably 80 °C to 500 °C, more preferably 120 °C to 300 °C, for a predefined time period, for forming electroceramic composite material on the surface of the sacrificial material, wherein at least part of the sacrificial material 102 is allowed to react with the metal oxide precursor to form metal oxide in the electroceramic composite material 101. Optionally the method may further comprise removing any unreacted sacrificial material from the surface of the electroceramic composite material by treatment with water. See FIGS. 1 and 2A.

In the preparation of electroceramic composite structure according to an exemplary embodiment, the sacrificial material layer 102 may be dissolved into water to remove the sacrificial material, making the electroceramic composite structure 101 hollow. The hollow electroceramic composite structure thus obtained may be reinforced by post-processing before dissolving away the sacrificial material. See FIG. 2B.

A cavity 107 of a desired shape in the hollow electroceramic composite structure 101 may appear after dissolving the sacrificial material with water or rinsing with water. See FIG. 2B.

Electrodes may be prepared on the structure by using conductive printing ink such as conductive silver ink.

It is possible to prepare an electroceramic structure that is a multilayer structure, with multiple layers of electroceramic composite prepared on top of each other. Thus the ceramic structure may have multiple layers of ceramic. If desired, network electrodes compressed into a shape may be placed between the ceramic layers, and various amounts of active fillers may be used in the layers. The resulting gradient structure may be utilized in matching the impedance of the composite to the environment to be measured, e.g. in hydrophone applications. An embodiment involves making a round or cylindrical cavity inside the electroceramic composite structure. The sacrificial material may have a shape of e.g. a ball or cylinder, wherein a thin cylinder forms a channel extending to the surface of the composite. The ceramic may be compressed, for example, in a steel cylinder mold, after which the sacrificial material may be removed from the structure through the channel 106 by dissolving with water. See FIG. 2B.

In an embodiment, a hollow electroceramic composite structure may be prepared using water-insoluble ceramic 302, 303, 304, wherein internal electrodes 307, 308 are incorporated in the structure using a metal electrode network compressed into a suitable shape. The electrode network is which is placed in the mold between the different layers of the ceramic material 302, 303, 304, and/or between the ceramic material 302 and the sacrificial material 301. The ceramic material layer may be placed over the sacrificial material layer, and the electrode network 307, 308 may be placed between the layers. Alternatively, the electrodes may be printed with conductive printing ink on top of a previous material layer before the next material layer is prepared. Due to the low temperature used in the compressing of the composite, the electrode material may also contain, for example, solders and electrode metals (such as aluminium) that do withstand high sintering temperatures. See FIG. 3.

In an embodiment, the sacrificial material may be coated with conductor material with conductive printing ink, for example, conductive silver printing ink, before the sacrificial material is covered by the ceramic composite material. During the compressing according to the present method, the ceramic composite material adheres to the conductive ink material, so that the electroceramic composite structure to be manufactured already includes the electrode arrangement when the sacrificial material is removed by dissolving. Electronic components may also be embedded in the sacrificial material, in order to incorporate electronic components inside the resulting electroceramic composite structure prepared by the present method.

In an embodiment, the binder contained in the electroceramic composite 101, and the sacrificial material 102 may be selected in such a way that the sacrificial material 102 releases a compound 103 reacting with the binder, which may cause the binder to react to form a metal oxide. Examples of such sacrificial materials may include barium hydroxide hexahydrate as a water soluble salt in the sacrificial material, and titanium tetramethoxide as a reactive binder in the ceramic. Crystal water released from the barium hydroxide may cause a removal of methyl groups from the organotitanate compound (such as titanium tetramethoxide), so that the titanate may form titanium oxide. In addition, the organotitanate compound may react with barium, forming amorphous barium titanate on the surface of the composite structure being manufactured. See FIG. 2A.

In an embodiment, functional structures may be made from the electrode network 401 inside the cavity of the hollow electroceramic composite structure 101. For example, a hollow electroceramic structure 101 may be prepared that comprises an electrode network 401 as an electrical sensor or actuator. The electrical sensor may be inside or on a surface of the hollow electroceramic composite structure 101. The electrode network 401 may either be coated with a catalytic coating, or it may be used as such in the structure. The electrical sensor may be prepared from material, the electrical response of which changes due to compounds or particles attaching to the surface of the electrode network. The electrode network 401 may be cleaned by heating it with electric current. The surrounding ceramic structure is able to withstand the heating etc. without any problems. This may be used, for example, in sensing carbon black particles. The structure may also be made so as to contain multiple electrode network layers. See FIGS. 4 and 5.

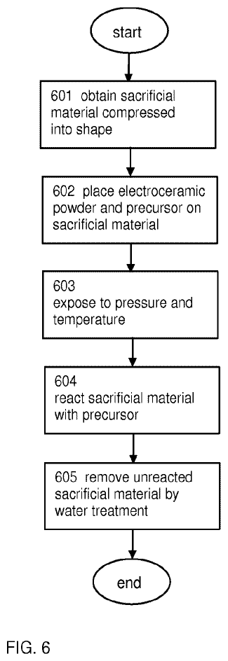

FIG. 6 is a flow chart illustrating manufacturing a hollow electroceramic composite structure according to the present invention. In FIG. 6, sacrificial material compressed into a desired shape is provided 601, the sacrificial material comprising water-soluble salt. A combination of electroceramic powder and flowable metal oxide precursor is placed 602 on a surface of the sacrificial material compressed into the desired shape. A pressure of 100 MPa to 500 MPa is applied 603 to said combination placed on the surface of the sacrificial material, and said combination placed on the surface of the sacrificial material is exposed 603, under said pressure to a temperature of 20 °C to 500 °C, preferably 80 °C to 500 °C, more preferably 120 °C to 300 °C, for forming electroceramic composite material on the surface of the sacrificial material, wherein at least part of the sacrificial material is allowed to react 604 with the metal oxide precursor to form metal oxide in the electroceramic composite material. Optionally, any unreacted sacrificial material is removed 605 from the electroceramic composite material by treatment with water.

In an embodiment, the electrode network may be used as a surface material of the ceramic composite, allowing light or heat to penetrate the composite material. This also enables utilization of thermoelectric and photoelectric phenomena in the composite material.

In an embodiment, reactive sacrificial material may be used in the production of all-ceramic composite. Hollow structures may be prepared from all-ceramic composite at a low temperature. Preparation of multi-layer convex structures is possible. Gradient structures may be prepared convexly or concavely from all-ceramic composite is possible.

In an embodiment, removing unreacted sacrificial material from the composite structure by treatment with water may involve dissolving, decanting, rinsing and/or spraying. Water used in the treatment and the unreacted sacrificial material are removed from the structure. Water used in the treatment may be removed by drying, for example, in an oven.

An embodiment enables low temperature manufacturing of electroceramic composites, by using a sacrificial layer, thereby producing multi-layered structures.

The structures may be made at a low temperature, at about 20 °C to 500 °C, such as 80 °C to 500 °C, for example, 120-300 °C

There is no need to machine the obtained final composite structure; the salt containing material used as the sacrificial material may be washed off with water.

The sacrificial material may participate in the formation of the chemical structure of the composite by releasing a reactive substance during compression.

Curved electrode structures, in one or more layers, may be incorporated into the composite structures during manufacturing of the composite.

Electrodes and/or other components may be introduced inside the ceramic composite by moving said electrodes and/or other components with the help of the sacrificial material, during manufacturing of the composite.

Gradients may be applied to the electrical properties of the different layers, so that the electrical or mechanical adaptation of the material to the surrounding conditions may be optimized.

The structure may be coated with a compound such as barium titanate, released from the sacrificial material during compressing.

An embodiment enables to produce curved, convex and/or hollow multi-layered structures from electroceramic material, which was previously very slow, expensive or even impossible.

In an embodiment, the hollow electroceramic composite structures obtained by the present method may be used in hydrophones or radio frequency applications.

An embodiment enables to manufacture an all-ceramic composite structure, wherein a hollow all-ceramic composite structure may be obtained by the method.

An embodiment facilitates manufacturing of an electroceramic composite structure with exact dimensions, since the deformation of the materials during compressing can minimised in the low temperature compression and by the usage of the sacrificial material.

### Example 1

A multilayer piezoelectric ceramic composite structure was manufactured at a temperature of 320 °C and at a pressure of 250 MPa by using the present method, thus obtaining a piezo factor d33 of 270 pC/N of the electroceramic composite structure. Thus the piezoelectric coefficient significantly increased compared to ceramic material sintered at 1200 °C, for which a piezoelectric coefficient d33 of 150 pC/N was obtained. In addition, it was possible to prepare a hollow and hemispherical piezoelectric structure by the present method.

It will be obvious to a person skilled in the art that, as the technology advances, the inventive concept can be implemented in various ways. The invention and its embodiments are not limited to the examples described above but may vary within the scope of the claims.

1.-22. (canceled)

23. A method for manufacturing a hollow electroceramic composite structure, the method comprising steps of
a) providing sacrificial material compressed into a desired shape, the sacrificial material comprising water-soluble salt;
b) placing a combination of electroceramic powder and flowable metal oxide precursor on a surface of the sacrificial material compressed into the desired shape;
c) applying a pressure of 100 MPa to 500 MPa to said combination placed on the surface of the sacrificial material; and
d) exposing said combination placed on the surface of the sacrificial material, under said pressure to a heat treatment at a temperature of 20 °C to 500 °C, preferably 80 °C to 500 °C, more preferably 120 °C to 300 °C, for a predefined time period, for forming electroceramic composite material on the surface of the sacrificial material, wherein at least part of the sacrificial material is allowed to react with the metal oxide precursor to form metal oxide in the electroceramic composite material;
wherein the water-soluble salt in the sacrificial material comprises hydrated salt and anhydrous salt;
wherein the allowing of the at least part of the sacrificial material to react with the metal oxide precursor to form the metal oxide in the electroceramic composite material comprises that crystal water contained in the hydrated salt in the sacrificial material is reacted with the metal oxide precursor to form the metal oxide in the electroceramic composite material.

24. A method as claimed in claim 23, wherein the method further comprises e) removing any unreacted sacrificial material from the electroceramic composite material by treatment with water.

25. A method as claimed in claim 23, wherein the allowing of the at least part of the sacrificial material to react with the metal oxide precursor to form the metal oxide in the electroceramic composite material comprises that
also the water-soluble salt in the sacrificial material is reacted with the metal oxide precursor to form the metal oxide in the electroceramic composite material.

26. A method as claimed in claim 23, wherein the water-soluble salt comprises a mixture of NaCl, KCl, and/or LiCl, with magnesium sulphate, MgCl₂, CaCl₂, and/or barium hydroxide.

27. A method as claimed in claim 23, wherein
the metal oxide precursor comprises organotitanate compound, such as titanium metoxide, or
the metal oxide precursor is in a form of a gel or sol-gel.

28. A method as claimed in claim 23, wherein
the sacrificial material is compressed into the desired shape by compressing an aqueous solution of the sacrificial material in a preform mould, wherein the aqueous solution of the sacrificial material is obtained by dissolving the water-soluble salt into water, and optionally water is removed from compressed sacrificial material by drying.

29. A method as claimed in claim 23, wherein the method comprises a treatment with water, comprising dissolving with water to dissolve said unreacted sacrificial material.

30. A method as claimed in claim 23, wherein said desired shape of the sacrificial material is a contoured structure, such as a cylinder, lens, prism, polyhedron, sphere, hemisphere, hollow cube, hollow cuboid, or other 3-dimensional shape.

31. A method as claimed in claim 23, wherein the hollow electroceramic composite structure obtained by the method is a contoured structure, such as a hollow cylinder, lens, hollow prism, hollow polyhedron, hollow sphere, hollow hemisphere, hollow cube, hollow cuboid, or other hollow 3-dimensional shape.

32. A method as claimed in claim 23, wherein the method comprises providing the electroceramic composite material with an electrode network, by providing the electrode network on the surface of the sacrificial material between steps a) and b); or providing the electroceramic composite material with conductive printing ink, by printing the conductive printing ink on the surface of the sacrificial material between steps a) and b).

33. A method as claimed in claim 23, wherein the method comprises
providing a layered structure of the electroceramic composite material by, between steps d) and e),
preparing a further layer of electroceramic composite material on a surface of a previous layer of the electroceramic composite material, by using said combination and by carrying said heat treatment under said pressure, and
providing an electrode network between the electroceramic composite material layers, wherein the electrode network is provided on the previous layer of the electroceramic composite material before preparing the further layer of electroceramic composite material, or printing conductive printing ink between the electroceramic composite material layers, wherein the conductive printing ink is printed on the previous layer of the electroceramic composite material before preparing the further layer of electroceramic composite material.

34. A method as claimed in claim 32, wherein the electrode network comprises metal,
wherein the metal is one or more of aluminium, silver, platinum, copper, brass, and/or steel.

35. A method as claimed in claim 23, wherein
the sacrificial material is barium hydroxide hexahydrate, and the flowable metal oxide precursor is an organotitanate compound,
wherein formed metal oxide is titanium oxide, and optionally barium titanate is formed in the hollow electroceramic composite structure.

36. A method as claimed in claim 32, wherein
the electrode network forms an electrical sensor inside or on a surface of the hollow electroceramic composite structure,
wherein optionally the electrode network is coated with a catalytic coating.

37. A method as claimed in claim 23, wherein the method comprises providing an electrode network on a surface of the hollow electroceramic composite structure, wherein the electrode network is added between steps b) and c).

38. A method as claimed in claim 23, wherein the heat treatment under said pressure is carried out in a product mould.

39. A method as claimed in claim 38, wherein
the electroceramic composite material is removed from the product mould before the removal of said unreacted sacrificial material from the electroceramic composite material, or the electroceramic composite structure is removed from the product mould after the removal of said unreacted sacrificial material from the electroceramic composite material.

40. A method as claimed in claim 23, wherein the electroceramic powder comprises
at least one of PZT, BaₓSr₁₋ₓTiO₃, TiO₂, Al₂O₃, KNBNNO, perovskite material, and ferrite ceramic material.

41. A method as claimed in claim 23, wherein
the flowable metal oxide precursor is water-insoluble, and
in the electroceramic powder, surfaces of electroceramic particles are covered with the metal oxide precursor, a major fraction of the electroceramic particles having particle diameters within a range 50 μm to 200 μm, and a minor fraction of the electroceramic particles having diameters smaller than the lower limit of said range, the major fraction having a variety of particle diameters.

42. A hollow electroceramic composite structure, wherein it is produced by the method of claim 23, wherein the hollow electroceramic composite structure comprises metal oxide formed of the sacrificial material reacted with the metal oxide precursor;
the sacrificial material comprising water-soluble salt, wherein the water-soluble salt in the sacrificial material comprises hydrated salt and anhydrous salt;
wherein the metal oxide is formed of crystal water contained in the hydrated salt reacted with the metal oxide precursor.

43. A hollow electroceramic composite structure as claimed in claim 42, wherein the hollow electroceramic composite structure is a contoured structure, such as a hollow cylinder, lens, hollow prism, hollow polyhedron, hollow sphere, hollow hemisphere, hollow cube, hollow cuboid, or other hollow 3-dimensional shape.

44. Use of sacrificial material comprising water-soluble salt for manufacturing a hollow electroceramic composite structure according to the method of claim 23.

45. A method as claimed in claim 33, wherein the electrode network comprises metal, wherein the metal is one or more of aluminium, silver, platinum, copper, brass, and/or steel.

46. A method as claimed in claim 33, wherein the electrode network forms an electrical sensor inside or on a surface of the hollow electroceramic composite structure, wherein optionally the electrode network is coated with a catalytic coating.

47. A method as claimed in claim 34, wherein the electrode network forms an electrical sensor inside or on a surface of the hollow electroceramic composite structure, wherein optionally the electrode network is coated with a catalytic coating.
